(19) United States
(12) Patent Application Publication
(10) Pub. No.: US 2014/0096804 A1
(43) Pub. Date: Apr. 10, 2014

(54) MOBILITY APPARATUS FOR PERSON WITH LOWER LEG INJURY

(71) Applicant: James Arnold Keck, Round Rock, TX (US)

(72) Inventor: James Arnold Keck, Round Rock, TX (US)

(21) Appl. No.: 13/646,108

(22) Filed: Oct. 5, 2012

(51) Int. Cl. A61H 3/02

(52) U.S. Cl. 135/69; 135/68; 135/72

(57) ABSTRACT

A leg supporting crutch apparatus includes a crutch having an underarm support structure, a support surface engagement structure, and a hand grip. A central portion of a torso engaging structure, which is between first and second end portion thereof, is attached to the central portion of the crutch at a location between the underarm support structure and the hand grip. A leg support assembly is attached to the central portion of the crutch at a location between the hand grip and the support surface engagement structure. The leg support structure includes a platform on which a lower leg portion of a person using the leg supporting crutch apparatus can be supported while the torso engaging structure is secured to a torso of the person and the underarm support structure is positioned under an armpit of the person.

### FIELD OF THE DISCLOSURE

The disclosures made herein relate generally to mobility aids for injured persons and, more particularly, to a mobility apparatus for a person with a lower leg injury.

### BACKGROUND

It is well known that a leg or knee injury can be demobilizing to a person. For example, as a result of a lower leg injury (e.g., an ankle injury), a person recovering from the injury (e.g., including surgery resulting therefrom) is often required to avoid any loading on the lower leg, ankle, and foot for several weeks. For most people who live an active lifestyle, this is an unacceptably long period of time to be immobile.

There are numerous apparatuses intended for enabling a person's mobility during recovery from a lower leg injury. Examples of these known mobility apparatuses include, but are not limited to, standard crutches, a wheel chair, a sit-in walker, and a wheeled knee-caddy. However, each one of these known mobility apparatuses exhibits one or more shortcoming that limits its usefulness and practicality. For example, known mobility apparatuses such as a wheel chair, a sit-in walker, and a wheeled knee-caddy lack usefulness and practicality due to being bulky, restrictive, inconvenient, and/or costly. Standard crutches are generally relatively inexpensive and do aid in providing at least limited mobility, but their use can result in frustration and fatigue for reasons such as soreness of the armpits and inability to use the hands for anything except for holding handles of the crutches.

An alternative to standard crutches is a mobility apparatus commonly known as a dedicated hands-free lower leg crutch. This type of crutch straps to the lower leg and thigh of a person without any similar form of attachment to the torso of the person. In addition to being costly compared to standard crutches, this type of crutch has the shortcomings of being relatively expensive and generally inconvenient. Attaching the dedicated hands-free lower leg crutch requires a considerable amount of time, which can result in a long transition time from sitting without the crutch attached to walking with the crutch attached. Furthermore, due to being strapped only to the lower leg and upper thigh, this type of crutch offers limited stability, which can result in fatigue and discomfort from attempting to compensate for such limited stability.

Therefore, a mobility apparatus that overcomes shortcomings associated with known mobility apparatuses would be advantageous, desirable and useful.

### SUMMARY OF THE DISCLOSURE

Embodiments of the present invention are directed to a leg supporting crutch apparatus (i.e., a mobility apparatus) that, unlike previous crutches, straps to not only the lower leg (e.g., thigh and calf) but also to the torso. In addition, it can be further stabilized by an upper side pad that rests against the side of the rib cage area just below the armpit of the person using the apparatus. However, unlike previous mobility apparatuses (e.g., standard crutches, a wheel chair, a sit-in walker, a wheeled knee-caddy, etc), a leg supporting crutch apparatus configured in accordance with an embodiment of the present invention is not bulky, restrictive, inconvenient, or costly and, thus, does lack the associated usefulness and practicality of such previous mobility apparatuses. Furthermore, a leg supporting crutch apparatus configured in accordance with an embodiment of the present invention is relatively inexpensive, aids in providing a considerable degree of mobility, is easy to attach and use, does not cause soreness of the armpits, and allows the free use of hands for tasks besides holding the crutch handle. In this regard, mobility apparatuses configured in accordance with the present invention advantageously overcomes one or more shortcomings associated with previous mobility apparatuses.

In one embodiment of the present invention, a mobility apparatus for use by a person with an injured lower leg comprises an upper support structure, a lower support structure, a torso strap, and a leg support platform. The upper support structure has two vertical support members and a transverse support member. The vertical support members extend substantially parallel to each other and are spaced-apart from each other. The transverse support member is attached between a first end portion of each one of the vertical support members. The lower support structure is attached at a first end portion thereof to a second end portion of each one of the vertical support members. The torso strap is attached to each one of the vertical support members at a position adjacent to a central portion of each one of the vertical support members. The leg support platform is attached to each one of the vertical support members at a position adjacent to the second end portion of each one of the vertical support members.

In another embodiment of the present invention, a leg supporting crutch apparatus comprises a crutch, a torso engaging structure, and a leg support assembly. The crutch has an underarm support structure at a first end portion thereof, a support surface engagement structure at a second end portion thereof, and a hand grip at a central portion thereof. The torso engaging structure has a first end portion, a second end portion, and a central portion between the first and second end portions thereof. The central portion of the torso engaging structure is attached to the central portion of the crutch at a location between the underarm support structure and the hand grip. The leg support assembly is attached to the central portion of the crutch at a location between the hand grip and the support surface engagement structure. The leg support structure includes a platform on which a lower leg portion of a person using the leg supporting crutch apparatus can be supported while the torso engaging structure is secured to a torso of the person and the underarm support structure is positioned under an armpit of the person.

In another embodiment of the present invention, a kit is provided for modifying a crutch having an underarm support structure at a first end portion thereof, a support surface engagement structure at a second end portion thereof, and a hand grip at a central portion thereof. The kit comprises a crutch side pad, a torso strap, and a leg support platform. The crutch side pad has a crutch engagement structure configured for being attached to crutch at the first end portion thereof. A portion of the crutch side pad extends downward along a first side of the crutch when the crutch side pad is attached to the crutch. The torso strap has a first end portion, a second end portion, and a central portion between the first and second end portions thereof. The central portion of the torso strap includes a crutch engagement structure configured for being attached to the central portion of the crutch at a location between the underarm support structure and the hand grip. A lower leg portion of a person using the crutch can be supported on the leg support platform while a crutch engagement structure of the leg support platform is attached to the central portion of the crutch at a location between the hand grip and the support surface engagement structure. In this regard, at least one embodiment of the present invention is a kit having components that that can be readily attached to a conventional (i.e., walking-type) crutch.

For normal operation of a leg supporting crutch apparatus configured in accordance with the present invention, the user straps the lower leg into the leg support platform and then wraps the torso strap around both the upper waist/kidney area of the body. The torso strap is either attached to the crutch or wrapped around the crutch. When there is a need to only walk a short distance and the use of both hands is not required, the user can simply rest the injured leg in the leg support platform and use the underarm support structure (i.e., an arm rest) and the hand grip in a more conventional manner as a means to immediately get up and walk without the need to engage the torso strap or leg straps that can be part of the leg support assembly. Otherwise, the torso strap easily and comfortably retains and stabilizes the crutch near the side of the body so the user can walk or stand with confidence even without grasping the hand grip, if desired. With proper adjustment, no weight is necessary on the armpit because the body weight is now supported by the knee and upper leg. The underarm support structure arm rest primarily acts as an additional stabilizing component because the body weight applied to the leg support platform results in a small lateral force between the underarm support structure and the side of the user's rib cage (i.e., just below the armpit) due to the small offset distance between the leg support platform and vertical support members of the crutch.

As will be appreciated from the disclosures made herein, the benefits of a mobility apparatus configured in accordance with the present invention relate to its multi-functional capability, comfort, simplicity, versatility, ease of use, and low cost. Users who are already familiar with conventional crutch usage will quickly and easily adapt to this new mobility apparatus. One of the most significant benefits of this new mobility apparatus is the ability to rise from a sitting position while holding the crutch of the mobility apparatus and simultaneously sliding the user's knee into the leg support platform. This allows immediate walking with only the single crutch and without the need for the leg or torso straps. If desired, the user can continue to use two crutches (e.g., a conventional crutch in combination with the new mobility apparatus), but with the added benefit of little or no pressure on either armpit. The crutch of the new mobility apparatus retains its normal built-in adjustability and the add-on components to the crutch (i.e., the torso strap, the leg support assembly, and the arm rest pad) can be configured so that they can be readily removed from the crutch without any affect on the original design or utility of the crutch.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is first side view of a leg supporting crutch apparatus in accordance with an embodiment of the present invention.

FIG. 2 is second side view of the leg supporting crutch apparatus shown in FIG. 1.

FIG. 3 is a rear view of the leg supporting crutch apparatus shown in FIG. 1.

FIG. 4 is a side view showing the leg supporting crutch apparatus shown of FIG. 1 attached to a user.

FIG. 5 is a rear view showing the leg supporting crutch apparatus shown of FIG. 1 attached to a user.

### DETAILED DESCRIPTION

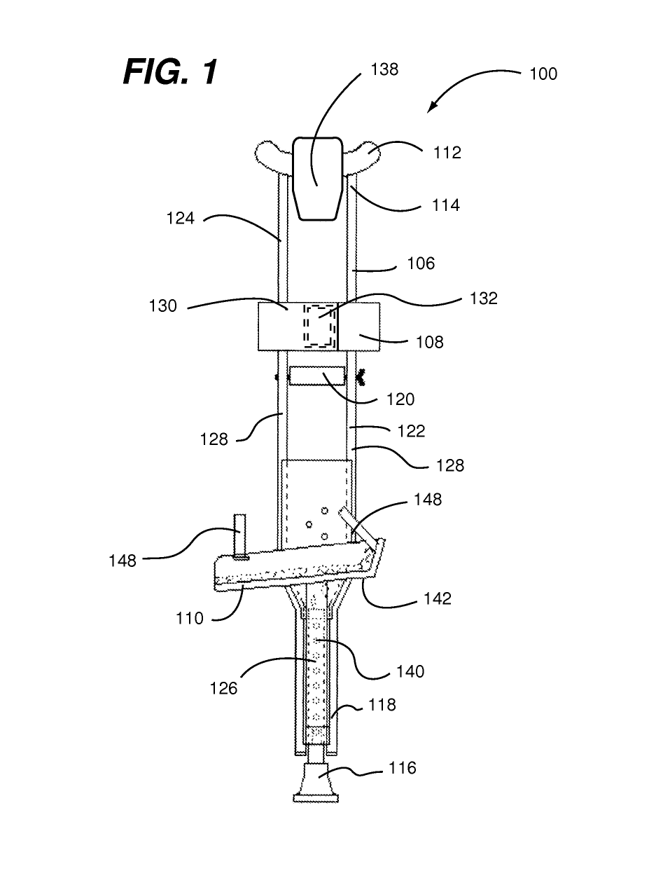

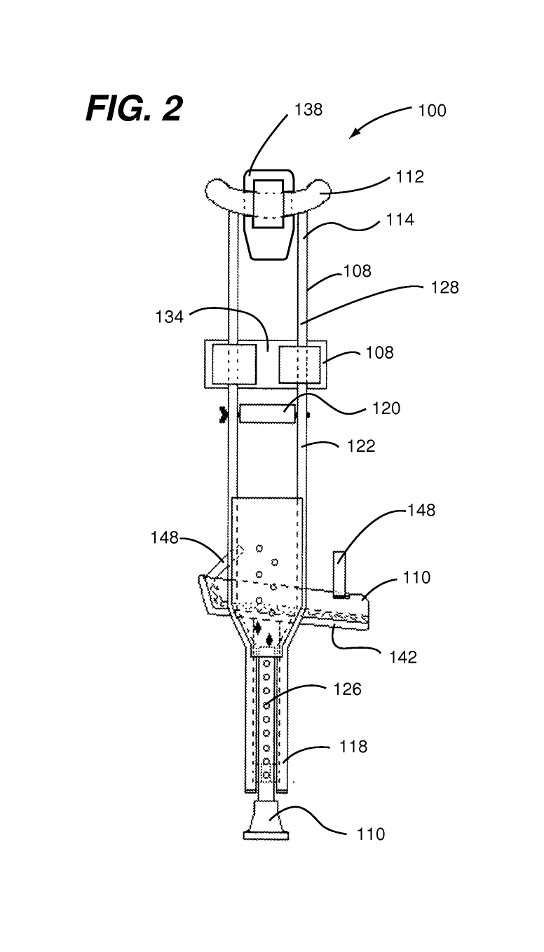

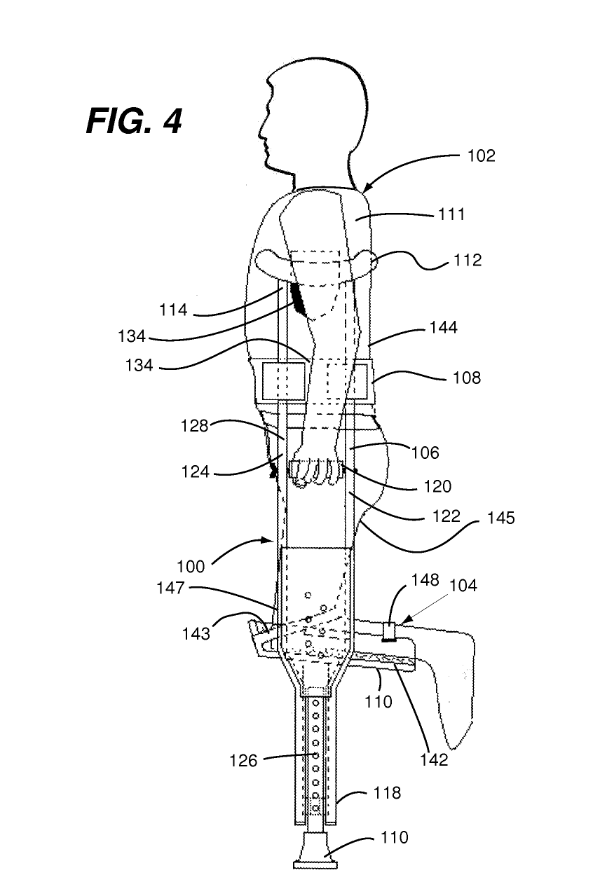

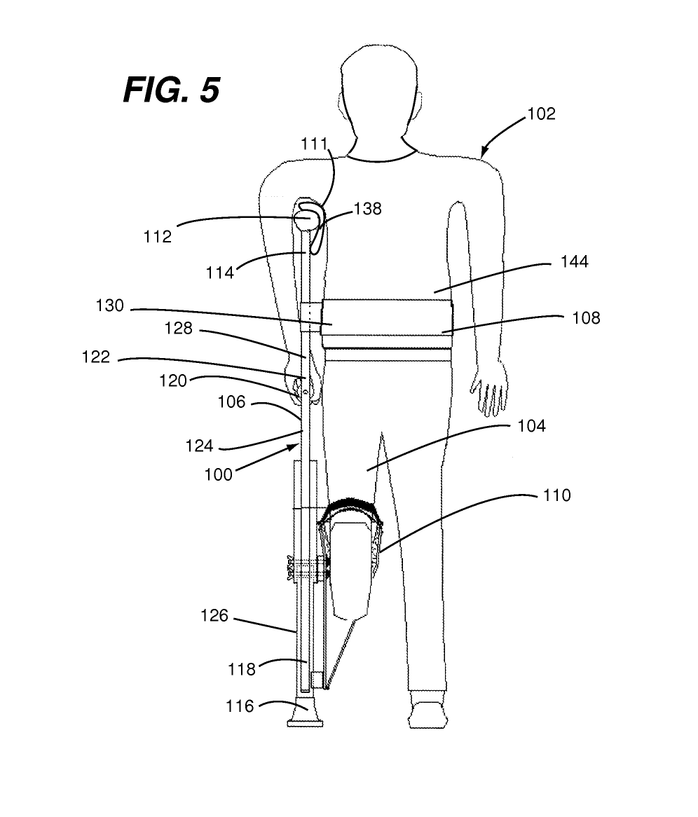

FIGS. 1-5 show a leg supporting crutch apparatus 100, which is an embodiment of a mobility apparatus configured in accordance with the present invention. The leg supporting crutch apparatus 100 is configured for use by a person 102 (FIGS. 4 and 5) with an injured lower leg 104. The leg supporting crutch apparatus 100 includes a crutch 106, a torso strap 108 and a leg support assembly 110. The crutch 106 is a substantially rigid structural unit that extends from an underarm region (e.g., arm pit 111) of the person 102 to the floor (i.e., a support surface). For example, the crutch 100 can be identical to a conventional (i.e., prior art) crutch or a conventional crutch that has been suitably modified for having the torso strap 108 and the leg support platform 110 attached thereto.

As will be discussed below in greater detail, the torso strap 108 and the leg support assembly 110 are mounted on the crutch 106. Because the crutch 106 extends from the support surface up to just below the armpit 111 of the person 102 and the leg support assembly is mounted to an inside (i.e., first) surface of the crutch 106, the weight of the person 102 results in a nominal lateral force to the crutch 106. The magnitude of this lateral force is a function of the person's weight, the offset distance between a lower leg support surface of the leg support assembly 110 and vertical axis of the crutch 106, and the overall length of the crutch 106. This lateral force acts as a stabilizing force that is held in check (e.g., counteracted) by contact between an underarm support structure 112 of the crutch and the person's body as well as the torso strap 108, which acts as a pivot point. The end result is much more stability and reduced tendency for uncontrolled oscillation of the crutch 106 than would be the case for a lower leg crutch (i.e., also sometimes referred to as a knee-walk crutch) that only attaches to the lower leg and thigh.

The crutch 106 has the underarm support structure 112 (i.e., an arm rest) at its first end portion 114, a support surface engagement structure 116 at its second end portion 118, and a hand grip 120 at its central portion 122. The underarm support structure 112 and the hand grip 120 can each have a body engaging surface that is padded or otherwise compliant. As shown, the crutch 106 can have an upper support structure 124 and a lower support structure 126. The upper support structure 124 has two vertical support members 128 and a transverse support member (i.e., the underarm support structure 112 which can serve as an arm rest). The vertical support members 128 extend substantially parallel to each other and are spaced-apart from each other. The underarm support structure 112, which is an example of a traverse member of the crutch 106), is attached between a first end portion of each one of the vertical support members 128. The lower support structure 126 is attached at its first end portion to a second end portion of each one of the vertical support members 128, such as by threaded fasteners. Preferably, the hand grip 120 and the lower support structure 126 are each vertically adjustable along a length of the vertical support members 128 (e.g., a plurality of spaced apart holes in the vertical support members 128 and, optionally in the lower support structure 126).

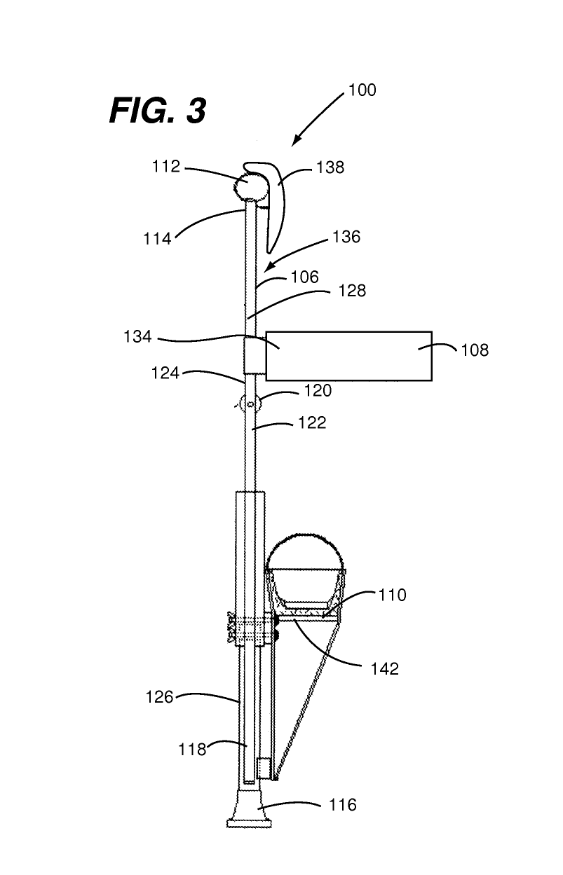

The torso strap 108, which his an example of a torso engaging structure, has a first end portion 130, a second end portion 132, and a central portion 134 between its first and second end portions 130, 132. The central portion 134 of the torso strap is attached to each one of the vertical support members 128 at a location between the underarm support structure 112 and the hand grip 120. Preferably, but not necessarily, the torso strap 108 is made from a material (e.g., woven nylon) that is flexible, conformable, compliant, and/or the like. The torso strap 108 has mating fastening members (e.g., hook and loop fastening members) at its first and second end portions 130, 132 for allowing its first and second end portions 130, 132 to be secured to each other. The torso strap 108 can be attached to each one of the vertical support members 128 through a loop, or loops, that are integrally formed within the torso strap 108. The loops are an example of a spacer structure that offset (e.g., 0.5-3.0 inches) the body securing portion of the torso strap 108 (i.e., the portion of the torso strap 108 that is engaged with the person's body) away from a first side 136 (FIGS. 3 and 5) of the crutch 106. This interface between the torso strap 108 and the crutch 106 laterally constrains and stabilizes the vertical supporting members 128 while at the same time providing a pivot point for the vertical support members 128 at the side of the user at the torso strap location. Furthermore, the torso strap 108 is preferably attached to the vertical support members 128 in a manner allowing the torso strap 108 to be vertically adjusted along a length of the vertical support members 128. For example, the vertical support members 128 and integrated loops of the torso strap can be captured in a passage of a crutch engagement structure (e.g., sewn on or integral fabric loops/panels) of the torso strap 108 thereby jointly providing for slight lateral offset and vertical translation of the torso strap 108 with respect to the vertical support members 128. In this regard, the loops provide a spacer structure that offers compliance or flexibility at the interface between the crutch 106 and the body securing portion of the torso strap 108 and that offset the body securing portion of the torso strap away from the first side 136 of the crutch 106.

The leg supporting crutch apparatus 100 can include a crutch side pad 138 having a crutch engagement structure attached to the underarm support structure 112. For example, the crutch engagement structure of the crutch side pad 138 can be a strap that can be selectively fastened around the underarm support structure 112 and/or at least one of the vertical support members 128. Alternatively, the crutch side pad 138 can be a foam pad that is fastened around the underarm support structure 112 and/or to at least one of the vertical support members 128. Preferably, a portion of the crutch side pad 138 extends downward along the first side 136 of the crutch 106 for being engaged with a side of the person's body (e.g., a side of their ribcage adjacent to the armpit 111). Engagement of the torso strap 108 around the body of the person 102 helps pull the vertical support structures 128 and more specifically, the crutch side pad 138, against the person's side for additional stability.

The leg support assembly 110 is attached to each one of the vertical support members 128 at a position between the hand grip 120 and a second end portion (i.e., lower portion) of the lower support structure 126. The leg support assembly 110 includes a platform 142 (e.g., with a padded surface) on which the lower leg 104 of the person 102 is supported while the torso strap 108 is secured to a torso 144 of the person 102 and the underarm support structure 112 is positioned under the armpit 111 of the person 102. The leg support assembly 110 preferably holds the lower leg 104 at about a 90 to 100 degree angle to the upper leg 145 and causes the center of the knee 147 to be in line with or only slightly forward of the vertical axis of the forward-most one of the vertical support members 128. The platform 142 can have a contoured shape for following a mating contour of the lower leg 104 and/or for providing a structure that limits unrestricted forward translation of the lower leg 104 with respect to the platform 142. The leg support assembly 110 is attached to the crutch 106 in a manner allowing the leg support assembly 110 to be vertically adjusted with respect to vertical support members (e.g., in order to match the user's height). This adjustment is also required because the distance between the knee 147 and underarm support structure 112 should be set to avoid loading of the user's armpit. For example, to provide for such vertical adjustability, the leg support assembly 110 can attached directly to the vertical support members 128 and/or directly to the lower support structure 126 by means such as threaded fasteners that pass through holes in the vertical support members 128 and/or the lower support structure 126. Furthermore, the leg support assembly 110 can be coupled to the crutch 106 through some type of “T”, “V”, or similar track/rail system that allows relative translation along a vertical axis while limiting translation/rotation in other directions.

The leg support assembly 110 can include one or more leg retention straps 148 or other suitable means for securing the lower leg 104 of the person 102 to the platform 142. The leg retention straps 148 are required when using the leg supporting crutch apparatus 100 in a “hands-free” mode because they force the crutch 106 to move with the knee 147 so that the crutch 106 produces the required walking motion. If the leg retention straps are not engaged, the user can still use the hand grip 120 to pull slightly upward on the crutch 106 to maintain engagement between the leg/knee and the leg support assembly 110 while walking. This is advantageous when the user just wants to stand or walk a short distance without installing any of the straps.

As will be appreciated by a skilled person in vie3w of the disclosures made herein, the leg supporting crutch apparatus 100 is used in place of a standard pair of walking crutches (i.e., conventional crutches) that might normally be issued to a person with a disabled lower leg (i.e., lower leg, foot, and/or ankle) The leg supporting crutch apparatus 100 enables a user to stand or walk with a single-crutch and to maintain the use of their hands and arms. The leg supporting crutch apparatus 100 also provides a fixed support for the disabled lower leg, which is important for enhancing mobility and for aiding in recovery of the injured lower leg. Furthermore, the leg supporting crutch apparatus 100 provides the optional usage of allowing the user to rest the lower leg on the leg support platform 142 while holding the crutch 106 in a more conventional manner with one arm and hand to quickly get up and move about without the need to use the straps 148.

The crutch 106 supports the body load and extends from a support surface (e.g., floor) upward so that the underarm support structure 112 is just below an armpit 111 of the person 102 (i.e., the same as for a conventional crutch). For example, the height of the crutch 106 is adjusted to maintain about a one or two inch clearance between the armpit 111 and the underarm support structure 112. This clearance allows the person 102 the option to use a hand grip 113 of the crutch 106 in a more conventional manner by slightly arching the back and tucking the underarm support structure 112 into the armpit 111 while holding the hand grip 120, or to just allow the crutch side pad 138 to rest against the rib cage during hands-free walking.

In order to use the full functionality of the leg supporting crutch apparatus 100, a user performs a plurality of actions prior to use in walking. One such action is to adjust the overall height of the crutch and leg support assembly so that the arm rest (i.e., underarm support structure) is about 2 inches below the arm-pit when the leg and knee is resting on the platform of the leg support assembly with the user in a standing position so that the knee is in line, or slightly forward of the vertical center axis of the crutch (i.e., the upper support structure thereof). Another such action is to adjust the hand grip so the arm is only slightly bent when it is being held. Another such action is to adjust and engage the leg straps around the lower leg so it is held firmly in the leg support platform. Still another such action is to adjust and engage the torso strap snugly around the waist/kidney and vertical support structure of the crutch. The torso strap adjustment must be snug around the waist/kidney area of the body.

During use of the leg supporting crutch apparatus 100 (i.e., after securing the lower leg to the leg support assembly and securing the torso strap around the user's body), the user lifts the crutch slightly (e.g., with a slight rocking motion of the hip or body) while standing so that a skid-resistant member at the support surface engaging end of the crutch lifts up, allowing the user to swing the knee forward (i.e., similar to normal walking motion). The user has the option to hold the hand grip during walking or standing. Once familiar with use of the leg supporting crutch apparatus 100, the user can begin to depend less on the hand grip so that full hands-free mode can be used. The torso strap provides stability as well as a flexible pivot point for the crutch during standing and walking. Similarly, the user can then also choose to not use any of the retention straps on the leg or waist, and instead use one hand operation by pulling upward on the hand grip to hold the leg and knee in place on the leg support platform for standing and for walking short distances. In order to sit down in an armless chair with the leg supporting crutch apparatus 100 still fully attached to the lower leg, the user can disengage the torso strap only and carefully sit down as normal.

In view of the disclosures made herein, a skilled person will appreciate that a mobility apparatus configured in accordance with an embodiment of the present invention has several advantages with respect to previous mobility solutions. One such advantage is that an injury or disability to the foot, ankle, or lower leg that would previously require the use of two crutches, both hands, and both armpits, now only requires a single adjustable crutch system that is stabilized by a torso strap, arm pad, hand grip, and lower leg platform that rigidly supports the lower immobile leg, and at the same time permits the body weight to be supported by the knee for standing or walking without requiring the use of the hands. Another such advantage is that the inventive mobility apparatus permits walking and standing in conjunction with the freedom to use of one or both hands. Another such advantage is that the inventive mobility apparatus provides a fixed support and restraint system for the unusable lower leg while walking or standing. Another such advantage is that the inventive mobility apparatus provides much greater degree of mobility, comfort, independence and less coordination and physical effort compared to conventional hand and arm operated crutches and knee-walking or hands-free devices. Another such advantage is that the inventive mobility apparatus reduces or eliminates armpit fatigue. Another such advantage is that the inventive mobility apparatus can be offered either as a stand-alone system or as attachments (e.g., in kit form) that are added to a single existing conventional crutch without negative impact to the load carrying integrity, adjustability, or original function of the conventional crutch. Another such advantage is that the inventive mobility apparatus permits the user to sit in a standard armless chair if the torso strap is removed while keeping the leg support platform strapped to the leg. Another such advantage is that the inventive mobility apparatus allows the emulation of a conventional crutch in the sense that the user can hold it in place with one hand and arm while resting the leg on the platform and standing or walking about without the need to engage the leg or torso straps. Another such advantage is that the inventive mobility apparatus offers the user access to partial benefits of the system in cases where they may want to transition quickly from a sitting to a standing and walking condition by using the lower leg support platform in conjunction with the hand grip and arm rest in the conventional manner, i.e., the user can quickly and seamlessly engage the unit from a sitting to standing position in one fluid motion and move about using the hand grip to hold the unit in place while standing or walking. This is especially convenient when it is desired to quickly use the system for standing or just walking short distances. Still another such advantage is that the inventive mobility apparatus permits the option to still use a second conventional crutch if desired.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

1. A leg supporting crutch apparatus for use under one armpit of a person with an injured lower leg, comprising:
an upper support structure having two vertical support members and a transverse support member, wherein the vertical support members extend substantially parallel to each other and are spaced-apart from each other and wherein the transverse support member is attached between a first end portion of each one of the vertical support members;
a lower support structure attached at a first end portion thereof to a second end portion of each one of the vertical support members;
a leg support platform attached to each one of the vertical support members at a position adjacent to the second end portion of each one of the vertical support members;
a hand grip attached to and extending between the vertical support members at a position between the traverse member and the leg support platform; and
a torso strap attached to both of the vertical support members at a position between the hand grip and the transverse support member.

2. The leg supporting crutch apparatus of claim 1, further comprising:
a crutch side pad having a crutch engagement structure attached to the traverse member, wherein a portion of the crutch side pad extends downward along a first side of the upper support structure.

3. (canceled)

4. The leg supporting crutch apparatus of claim 1 wherein:
the torso strap is attached to each one of the vertical support members through a spacer structure that offsets a body securing portion of the torso strap away from a first side of the upper support structure;
a first side surface of each one of the vertical support members jointly define the first side of the upper support structure;
a body securing portion of the torso strap is located on the first side of the upper support structure;
the leg support platform is located on the first side of the upper support structure; and
the spacer structure offsets the body securing portion of the torso strap laterally away from the first side of the upper support structure by a distance approximately equal to a distance that an inner-most edge portion of the lei su ort platform is offset laterally from the first side of the upper support structure.

5. The leg supporting crutch apparatus of claim 1 wherein:
the torso strap is attached to the vertical support members in a manner allowing the torso strap to be vertically adjusted along a length of the vertical support members;
the lower support structure is attached to the vertical support members in a manner allowing the lower support structure to be vertically adjusted with respect to vertical support members; and
the leg support platform is attached to the vertical support members in a manner allowing the leg support platform to be vertically adjusted with respect to vertical support members.

6. The leg supporting crutch apparatus of claim 5, further comprising:
a crutch side pad having a crutch engagement structure attached to the traverse member, wherein a portion of the crutch side pad extends downward along a first side of the upper support structure.

7. The leg supporting crutch apparatus of claim 6 wherein:
a first side surface of each one of the vertical support members jointly define a first side of the upper support structure;
a body securing portion of the torso strap is located on the first side of the upper support structure;
the leg support platform is located on the first side of the upper support structure;
the torso strap is attached to each one of the vertical support members through a spacer structure that offsets a body securing portion of the torso strap away from the first side of the crutch, and
the spacer structure offsets the body securing portion of the torso strap laterally away from the first side of the upper support structure by a distance approximately equal to a distance that an inner-most edge portion of the lei su ort platform is offset laterally from the first side of the upper support structure.

8. A leg supporting crutch apparatus for use under one armpit of a person, comprising:
a crutch having an underarm support structure at a first end portion thereof, a support surface engagement structure at a second end portion thereof, and a hand grip at a central portion thereof, wherein the crutch includes two spaced-apart vertical support members extend substantially parallel to each other, wherein the underarm support structure, the support surface engagement structure and the hand grip are each attached to and extend between the vertical support members and wherein a first side surface of each one of the vertical support members jointly define a first side of the crutch;
a torso engaging structure having a first end portion, a second end portion, and a central portion between the first and second end portions thereof, wherein the central portion of the torso engaging structure is attached to both of the vertical support members at a location between the underarm support structure and the hand grip and wherein a body securing portion of the torso strap is located on the first side of the crutch; and
a leg support assembly attached to the central portion of the crutch at a location between the hand grip and the support surface engagement structure, wherein the leg support structure includes a platform on which a lower leg portion of a person using the leg supporting crutch apparatus can be supported while the torso engaging structure is secured to a torso of the person and the underarm support structure is positioned under an armpit of the person and wherein the platform is located on the first side of the crutch.

9. The leg supporting crutch apparatus of claim 8, further comprising:
a crutch side pad having a crutch engagement structure attached to the underarm support structure, wherein a portion of the crutch side pad extends downward along a first side of the crutch.

10. The leg supporting crutch apparatus of claim 9 wherein a body securing portion of the torso engaging structure is offset laterally away from the first side of the crutch by a distance approximately equal to a distance that an inner-most edge portion of the platform is offset laterally away from the first side of the crutch.

11. The leg supporting crutch apparatus of claim 10 wherein:
the torso engaging structure is attached to the vertical support members in a manner allowing the torso engaging structure to be vertically adjusted along a length of the crutch; and
the leg support platform is attached to the vertical support members in a manner allowing the leg support platform to be vertically adjusted along a length of the crutch.

12. The leg supporting crutch apparatus of claim 8 wherein:
the torso engaging structure is attached to the vertical support members in a manner allowing the torso engaging structure to be vertically adjusted along a length of the crutch; and
the leg support platform is attached to the vertical support members in a manner allowing the leg support platform to be vertically adjusted along a length of the crutch.

13. A kit for modifying a crutch having two spaced apart vertical support members, an underarm support structure at a first end portion of the vertical support members, a support surface engagement structure at a second end portion of the vertical support members, and a hand grip at a central portion of the vertical support members, the kit comprising:
a crutch side pad having a crutch engagement structure configured for being attached to crutch at the first end portion thereof, wherein a portion of the crutch side pad extends downward along a first side of the crutch when the crutch side pad is attached to the crutch;
a torso strap having a first end portion, a second end portion, and a central portion between the first and second end portions thereof, wherein the central portion of the torso strap includes a crutch engagement structure configured for being attached to both of the vertical support members of the crutch at a location between the underarm support structure and the hand grip; and
a leg support platform on which a lower leg portion of a person using the crutch can be supported while a crutch engagement structure of the leg support platform is attached to the central portion of the crutch at a location between the hand grip and the support surface engagement structure.

14. The kit of claim 13 wherein:
the crutch engagement structure of the torso strap includes a structure for causing the torso strap to be offset away from the first side of the crutch when the crutch engagement structure of the torso strap is secured to the crutch; and
the structure for causing the torso strap to be offset away from the first side of the crutch causes a body securing portion of the torso strap to be offset laterally away from the first side of the crutch by a distance approximately equal to a distance that an inner-most edge portion of the leg support platform is offset laterally away from the first side of the crutch.

15. The kit of claim 13 wherein the crutch engagement structure is configured for allowing the torso strap to be vertically adjusted along a length of the crutch when the crutch engagement structure is engaged with the crutch.

16. The kit of claim 15 wherein:
the crutch engagement structure of the torso strap includes a structure for causing a body securing portion of the torso strap to be offset away from the first side of the crutch when the crutch engagement structure of the torso strap is secured to the crutch; and
the structure for causing the torso strap to be offset away from the first side of the crutch causes a body securing portion of the torso strap to be offset laterally away from the first side of the crutch by a distance approximately equal to a distance that an inner-most edge portion of the lei su ort platform is offset laterally from the first side of the crutch.

17. The kit of claim 13 wherein the crutch engagement structure of the torso strap includes a first portion engagable with a first one of the vertical support member of the crutch and a second portion engagable with a second one of the vertical support member of the crutch.

18. The kit of claim 17 wherein the first and second support member engagement portions of the crutch engagement structure are each configured for being slideable along a length of a respective one of the vertical support members when the crutch engagement structure of the torso strap is engaged with the crutch.

19. The kit of claim 17 wherein:
the crutch engagement structure of the torso strap includes a structure for causing a body securing portion of the torso strap to be offset away from the first side of the crutch when the crutch engagement structure of the torso strap is secured to the crutch; and
the structure for causing the torso strap to be offset away from the first side of the crutch causes a body securing portion of the torso strap to be offset laterally away from the first side of the crutch by a distance approximately equal to a distance that an inner-most edge portion of the leg support platform is offset laterally away from the first side of the crutch.
